(19) United States
(12) Patent Application Publication
(10) Pub. No.: US 2025/0334430 A1
(43) Pub. Date: Oct. 30, 2025

(54) PROVIDING AUTO-CALIBRATION OF ACCELEROMETER AND/OR HALL-SENSE POSITION COUNTER IN A CROSSING GATE MECHANISM

(71) Applicant: Siemens Mobility, Inc., New York, NY (US)

(72) Inventors: Paul Young, Louisville, KY (US); Richard Bamfield, Ruby Bay (NZ); David Nemes, Black Rock (AU)

(73) Assignee: Siemens Mobility, Inc., New York, NY (US)

(21) Appl. No.: 18/651,242

(22) Filed: Apr. 30, 2024

(51) Int. Cl. G01D 18/00; B61L 29/04; B61L 29/22; G01D 21/02; H02K 7/116; H02K 29/08; H02P 6/16

(52) U.S. Cl. CPC G01D 18/001; B61L 29/04; B61L 29/22; G01D 21/02; H02K 7/116; H02K 29/08; H02P 6/16; G01D 18/006

(57) ABSTRACT

A system of auto-calibration is provided in a crossing gate mechanism. The crossing gate mechanism comprises a shaft, a gate arm, a gate-down buffer, a brushless DC (BLDC) motor, a motor speed and position controller, an accelerometer and a hall-sense position counter. The system auto-calibrates the accelerometer and/or the hall-sense position counter when they are in disagreement due to temperature or due to some other phenomenon.

### BACKGROUND

### 1. Field

Aspects of the present disclosure generally relate to providing auto-calibration of accelerometer and/or hall-sense position counter in a crossing gate mechanism.

### 2. Description of the Related Art

Prior art would involve use of a rotary encoder attached to a shaft providing a third reference to which both could calibrate against. Also cam lobes on the shaft have been implemented in prior art to electro-mechanically detect when rotary positions have been passed when the shaft is rotating.

Therefore, auto-calibration of an accelerometer and/or a hall-sense position counter is needed when they are in disagreement due to the drift of either due to temperature or due to some other phenomenon.

### SUMMARY

Briefly described, aspects of the present disclosure relate to providing auto-calibration of accelerometer and/or hall-sense position counter in a crossing gate mechanism. This technology is intended to auto-calibrate the accelerometer and/or the hall-sense position counter when they are in disagreement due to temperature or due to some other phenomenon. With this technology, there is no need for a rotary encoder attached to the shaft, or for cam lobes detected electro-mechanically on the shaft. If another gate mechanism was built with an accelerometer and a hall-sense position counter, and the elements of this technology were not implemented, the accelerometer and hall-sense position counter could drift with respect to each other. This would be most easily observed at extreme temperatures, when a gate mechanism could become more unreliable as a result of this disagreement between the accelerometer and the hall-sense position counter.

In accordance with one illustrative embodiment of the present disclosure, a system of auto-calibration is provided in a crossing gate mechanism. The crossing gate mechanism comprises a shaft, a gate arm, a gate-down buffer, a brushless DC (BLDC) motor, a motor speed and position controller, an accelerometer, and a hall-sense position counter. The system to auto-calibrate the accelerometer and/or the hall-sense position counter when they are in disagreement due to temperature or due to some other phenomenon. After powering up, the crossing gate mechanism lowers the gate arm until it detects the gate-down buffer, which establishes a home position of the gate arm thus calibrating a shaft angular position to 0 degrees and the hall-sense position counter to 0 degrees. When the gate arm is raised to a “gate up” position, or lowered back to a “gate down” position, if the shaft angular position disagrees substantially with a hall-sense position counter value, then it becomes necessary to re-establish the home position of the gate arm, also called “re-homing” the gate arm. When re-homing the gate arm, the next time the crossing gate mechanism lowers the gate arm, the gate-down buffer is detected again to establish the home position of the gate arm thus auto-calibrating the shaft angular position back to 0 degrees and the hall-sense position counter back to 0 degrees.

In accordance with one illustrative embodiment of the present disclosure, a method of providing auto-calibration in a crossing gate mechanism is provided. The method comprises providing a shaft, providing a gate arm, providing a gate-down buffer, providing a brushless DC (BLDC) motor, providing a motor speed and position controller, providing an accelerometer and providing a hall-sense position counter. The method to auto-calibrate the accelerometer and/or the hall-sense position counter when they are in disagreement due to temperature or due to some other phenomenon. After powering up, the crossing gate mechanism lowers the gate arm until it detects the gate-down buffer, which establishes a home position of the gate arm thus calibrating a shaft angular position to 0 degrees and the hall-sense position counter to 0 degrees. When the gate arm is raised to a “gate up” position, or lowered back to a “gate down” position, if the shaft angular position disagrees substantially with a hall-sense position counter value, then it becomes necessary to re-establish the home position of the gate arm, also called “re-homing” the gate arm. When re-homing the gate arm, the next time the crossing gate mechanism lowers the gate arm, the gate-down buffer is detected again to establish the home position of the gate arm thus auto-calibrating the shaft angular position back to 0 degrees and the hall-sense position counter back to 0 degrees.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a system for auto-calibration of an accelerometer and/or a hall-sense position counter in a crossing gate mechanism in accordance with an embodiment of the present disclosure.

FIG. 2 illustrates a system of auto-calibration in a crossing gate mechanism in accordance with an embodiment of the present disclosure.

FIG. 3 (FIG. 3A and FIG. 3B as split parts of FIG. 3) illustrates a method to auto-calibrate the accelerometer and/or the hall-sense position counter when they are in disagreement due to temperature or due to some other phenomenon in accordance with an embodiment of the present disclosure.

FIG. 4 illustrates a field-programmable gate array (FPGA) for accelerometer tolerance (Gate-Down Re-Home) in accordance with an embodiment of the present disclosure.

FIG. 5 illustrates a method of providing auto-calibration of an accelerometer and/or a hall-sense position counter in a crossing gate mechanism in accordance with an embodiment of the present disclosure.

### DETAILED DESCRIPTION

Various technologies pertain to systems and methods that provide auto-calibration of an accelerometer and/or a hall-sense position counter in a crossing gate mechanism. This technology is about any gate mechanism, any crossing gate mechanism that has a brushless DC motor. The brushless DC motor provides hall sense signals. There needs to be a way of zeroing out the gate arm position. The signals that come from the motor do not know about the gate arm position, as they just know the rotation of the motor. So the accelerometer is used to sense the tilt of the gate arm. Now the accelerometer is a way of detecting the gate arm position. There is an initial calibration that zeroes everything out, but that can drift over time with temperature and other environmental conditions. That is why auto-calibration is required to bring things back to zero as drift occurs. So whenever the gate arm is horizontal, we know the gate arm is at 0 degrees and there has to be a way of auto-calibrating to that condition. And then there are ways of checking and double checking that. So when something drifts is it drifting for a good reason or for a bad reason. There's a mechanism here for correcting things. Whether or not it has been corrected because something is actually drifted for a good reason or for a bad reason, the system can actually continue to auto-calibrate until everything is back in a good shape. For auto-calibration, the accelerometer and the hall-sense position counter function together. The system needs something to determine the angle of the gate arm using the accelerometer, and the system needs something which tells it the rotation of the motor, which is the hall-sense position counter. The accelerometer could have been something else such as an angle detector. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present disclosure, they are explained hereinafter with reference to implementation in illustrative embodiments. In particular, they are described in the context of auto-calibration of an accelerometer and/or a hall-sense position counter in a crossing gate mechanism. Embodiments of the present disclosure, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

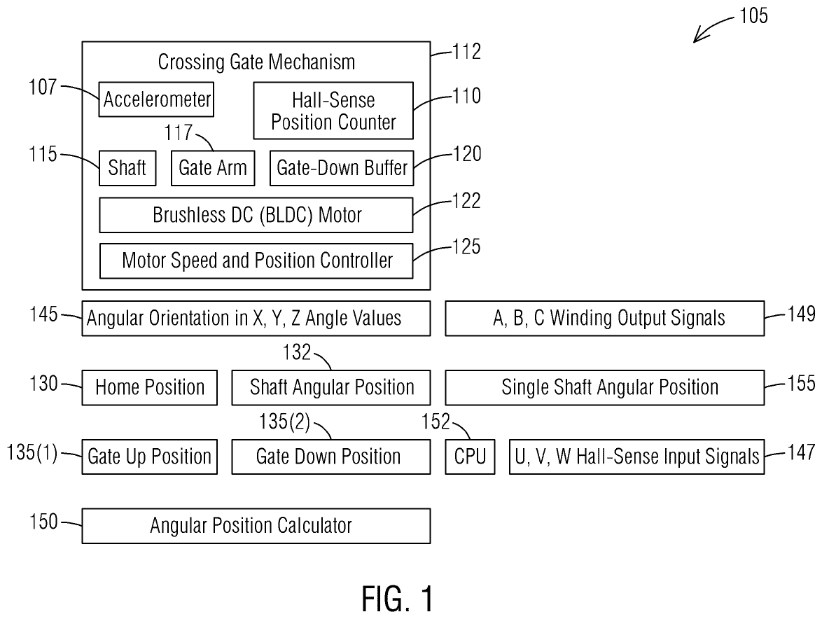

These and other embodiments of the system are provided for providing auto-calibration of an accelerometer and/or a hall-sense position counter in a crossing gate mechanism according to the present disclosure are described below with reference to FIG. 1 herein. The drawing is not necessarily drawn to scale.

Consistent with an embodiment of the present disclosure, FIG. 1 represents a system 105 of auto-calibration of an accelerometer 107 and/or a hall-sense position counter 110 in a crossing gate mechanism 112 in accordance with an embodiment of the present disclosure. The crossing gate mechanism 112 comprises a shaft 115, a gate arm 117, a gate-down buffer 120, a brushless DC (BLDC) motor 122, a motor speed and position controller 125, the accelerometer 107 and the hall-sense position counter 110.

The system 105 is configured to auto-calibrate the accelerometer 107 and/or the hall-sense position counter 110 when they are in disagreement due to temperature or due to some other phenomenon. After powering up, the crossing gate mechanism 112 lowers the gate arm 117 until it detects the gate-down buffer 120, which establishes a home position 130 of the gate arm 117 thus calibrating a shaft angular position 132 to 0 degrees and the hall-sense position counter 110 to 0 degrees.

When the gate arm 117 is raised to a “gate up” position 135(1), or lowered back to a “gate down” position 135(2), if the shaft angular position 132 disagrees substantially with a hall-sense position counter value (an output from the Hall-Sense Position Counter 110), then it becomes necessary to re-establish the home position 130 of the gate arm 117, also called “re-homing” the gate arm 117. When re-homing the gate arm 117, the next time the crossing gate mechanism 112 lowers the gate arm 117, the gate-down buffer 120 is detected again to establish the home position 130 of the gate arm 117 thus auto-calibrating the shaft angular position 132 back to 0 degrees and the hall-sense position counter 110 back to 0 degrees.

When re-homing the gate arm 117, the next time the crossing gate mechanism 112 lowers the gate arm 117, the gate-down buffer 120 is detected again to establish the home position 130 of the gate arm 117 thus auto-calibrating the shaft angular position 132 back to 0 degrees and the hall-sense position counter 110 back to 0 degrees.

There is no need for a rotary encoder attached to the shaft 115, or for cam lobes to provide an electro-mechanical position of the shaft 115. A rotary encoder is a type of sensor that detects position and speed by converting rotational mechanical displacement into electrical signals. It works by translating the movement of a rotating shaft into a series of digital pulses that can be used to determine the position and speed of the shaft. Cam lobes control the valve lift, and there is a direct relationship between the shape of the cam lobes and the way the engine performs in different speed. The lobes on the camshaft actuate the valve train in relation to the piston movement in an internal combustion engine. The camshaft determines when the valves open and close, how long they stay open and how far they open.

The gate arm 117 is lowered by the crossing gate mechanism 112 as a barrier to track-crossing traffic when a train is either approaching or passing. The gate-down buffer 120 is installed as a mechanical stop within the crossing gate mechanism 112 to establish a 0-degree “gate down” position for the gate arm 117. The shaft 115 is within the crossing gate mechanism 112 and holds the gate arm 117 at one end. The accelerometer 107 measures its own angular orientation in X, Y and Z angle values 145 (in reality the 3 axis accelerometer directly measures the components of gravity along its X,Y,Z axes, and the angular orientation is derived by the CPU calculation) such that the accelerometer 107 is mounted on the shaft 115 so that when the shaft 115 rotates to raise or lower the gate arm 117, the accelerometer 107 also moves and reports changes in its angular orientation in X, Y and Z angle values. A shaft angular position calculator 150 is software run by a Central Processing Unit (CPU) 152 that converts the X, Y and Z angle values into a single shaft angular position 155.

The brushless DC motor 122 is a driving force that rotates the shaft 115 and thereby raises or lowers the gate arm 117. The brushless DC motor 122 sends U, V and W hall sense input signals 147 to the hall-sense position counter 110 to increment or decrement that counter when the gate arm 117 is raised or lowered by the brushless DC motor 122. The motor speed and position controller 125 uses a counter value from the hall-sense position counter 110 to drive the A, B and C winding output signals 149 to rotate the brushless DC motor 122.

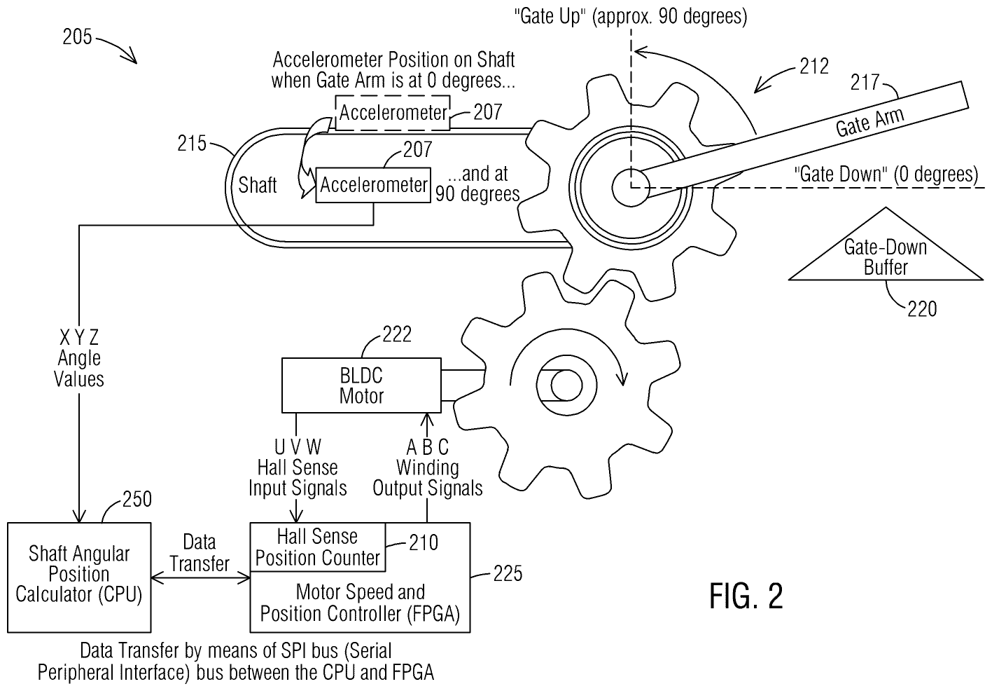

Referring to FIG. 2, it illustrates a system 205 of auto-calibration in a crossing gate mechanism 212 in accordance with an embodiment of the present disclosure. The idea is intended to auto-calibrate an accelerometer 207 and/or a hall-sense position counter 210 when they are in disagreement due to the drift of either due to temperature or due to some other phenomenon. Prior art would involve use of a rotary encoder attached to a shaft 215 providing a third reference to which both could calibrate against. Also cam lobes on the shaft 215 have been implemented in prior art to electro-mechanically detect when rotary positions have been passed when the shaft 215 is rotating. With this disclosure, there is no need for a rotary encoder attached to the shaft 215, or for cam lobes detected electro-mechanically on the shaft 215.

A Gate Arm 217 is lowered by the crossing gate mechanism 212 as a barrier to track-crossing traffic when a train is either approaching or passing. A Gate-Down Buffer 220 is installed as a mechanical stop within the crossing gate mechanism 212 to establish a 0-degree “Gate Down” position for the Gate Arm 217. The Shaft 215 is within the crossing gate mechanism 212 and holds the Gate Arm 217 at one end. The Accelerometer 207 measures its own angular orientation in X, Y and Z Angle Values. The Accelerometer 207 is mounted on the Shaft 215 so that when the Shaft 215 rotates to raise or lower the Gate Arm 217, the Accelerometer 207 also moves and reports changes in its angular orientation in X, Y and Z Angle Values. A Shaft Angular Position Calculator 250 is software run by the CPU that converts the X, Y and Z Angle Values into a single Shaft Angular Position.

A Brushless DC (or BLDC) Motor 222 is the driving force that rotates the Shaft 215 and thereby raises or lowers the Gate Arm 217. The BLDC Motor 222 sends U V and W Hall Sense Input Signals to the Hall Sense Position Counter 210 to increment or decrement that counter when the Gate Arm 217 is raised or lowered by the BLDC Motor 222. A Motor Speed and Position Controller 225 uses the counter value from the Hall Sense Position Counter 210 to drive the A B and C Winding Output Signals to rotate the BLDC Motor 222.

Below set forth Table I illustrates software code steps of an auto-calibration algorithm in accordance with an embodiment of the present disclosure.

TABLE I

| | |
|---|---|
| ID: SW_1 | This procedure reads the main shaft |
| (a) 2.5.2 Accelerometer | mounted accelerometer WHOAMI register |
| Main | and compares the value with the correct |
| ID: SW_2 | constant identity value. If three successive |
| | WHOAMI checks fail, the accelerometer is |
| | not communicating correctly and is |
| | unhealthy. |
| ID: SW_3 | The software checks the number of bytes in |
| | the FIFO, at six times the FIFO sample rate |
| | that was configured by |
| | Initialize_Accelerometer, using the non-vital |
| | timer that was started by |
| | Initialize_Accelerometer. When at least one |
| | complete set of X, Y, Z readings is present, |
| | the X, Y, Z values are read from the FIFO. |
| ID: SW_4 | If accelerometer auto calibration has been |
| | performed, the Y and Z values are adjusted |
| | to compensate for temperature drift. |
| | Procedure Compute_Raw_Gate_Angle is |
| | called to calculate the raw gate angle using |
| | just the Y and Z values. The adjusted gate |
| | angle is then calculated as the raw gate |
| | angle minus the ACCEL OFFSET value. |
| | The average time to acquire each set of X, |
| | Y, Z readings is measured over a one |
| | second period. If there is a timeout waiting |
| | for the readings or the time per sample set |
| | is not within +/−20 percent of the configured |
| | sample period, the accelerometer is |
| | unhealthy. If the accelerometer is |
| | unhealthy, the procedure calls shutdown, |
| | the raw gate angle and adjusted gate angle |
| | are cleared, and the GATE_UP and |
| | GATE_DOWN GPIO outputs that go to the |
| | FPGA are driven low. |
| | An FPGA, or field-programmable gate array, |
| | is a semiconductor integrated circuit that can |
| | be reprogrammed after manufacturing. |
| | FPGAs are made up of a matrix of |
| | configurable logic blocks (CLBs) connected |
| | by programmable interconnects. This allows |
| | customers to reconfigure the hardware to |
| | meet specific use case requirements after |
| | the manufacturing process. |
| ID: SW_5 | The software outputs an accelerometer |
| | position known bit to the FPGA. |
| ID: SW_6 | If the accelerometer is healthy and |
| | calibrated, the GATE_UP GPIO output, that |
| | goes to the FPGA, is driven active high |
| | when the adjusted gate angle is within 7 |
| | degrees from the programmed gate up |
| | position. |
| ID: SW_7 | If the accelerometer is healthy and |
| | calibrated, the GATE_DOWN GPIO output, |
| | that goes to the FPGA, is driven active high |
| | when the adjusted gate angle is within 5 |
| | degrees from the zero gate down position. |
| ID: SW_8 | This returns true if the accelerometer/hall |
| (a) 2.5.3 Is Gate | position tolerance check is passing. The |
| Angle In Tolerance | check will only fail when the FPGA Gate |
| ID: SW_9 | Status register Gate Down or Gate Up bits |
| | indicate the gate is down or the gate is up, |
| | and the adjusted accelerometer gate angle |
| | differs from the angle indicated by the |
| | FPGA Primary Arm Position register by at |
| | least 5 degrees over a period of at least 0.5 |
| | seconds. This means that rehoming is |
| | required to recalibrate the |
| | accelerometer/hall positions to correct for |
| | drift in the positions. |
| ID: SW_10 | Automatic recalibration of the accelerometer |
| (a) 2.5.4 Is | is allowed once one position calibration has |
| Accelerometer Auto | been performed and auto calibration has |
| Calibration Allowed | not already been done or the accelerometer |
| ID: SW_11 | temperature has changed by at least the |
| | step parameter from the last auto calibration |
| | accelerometer temperature and one or both |
| | of the accelerometer temperature and the |
| | last auto calibration accelerometer |
| | temperature is below the temperature limit |
| | for auto calibration. |
| ID: SW_12 | This procedure recalibrates the |
| (a) 2.5.5 Auto Calibrate | accelerometer using accelerometer |
| Accelerometer | readings collected when the gate was in the |
| Up Position | down position, close to half the |
| ID: SW_13 | programmed up position, and in the up |
| | position. For example, a MEMS |
| | accelerometer readings can drift |
| | considerably at low temperatures, and the |
| | recalibration is intended to compensate for |
| | the temperature drift. This procedure |
| | calculates the zero G offset and sensitivity |
| | parameters for the accelerometer Y and Z |
| | axes, and the gate down angle. These auto |
| | calibration parameters are saved for use by |
| | Accelerometer_Main. Prior to auto |
| | calibration, the zero G offset parameters are |
| | assumed to be zero, and the sensitivity |
| | parameters are assumed to be 1.0, which |
| | are the parameters values that an ideal |
| | device would have. If the calculated gate |
| | down angle differs from the gate down |
| | angle saved by the manual calibration by |
| | more than 12 degrees, the recalibration |
| | result is rejected by calling Shutdown to |
| | indicate an ACCEL_TOLERANCE_ERROR. |
| | This would happen if the accelerometer did |
| | not move with the shaft, or it slipped in |
| | either direction by an excessive amount. |
| ID: SW_100 | This procedure will be called when the gate |
| (a) 2.5.6 Auto Calibrate | is in the down position. It saves the |
| Accelerometer | accelerometer readings for later use by |
| Down Position | Auto_Calibrate_Accelerometer_Up_Position |
| ID: SW_101 | to compensate the accelerometer readings |
| | for sensor parameter drift. |

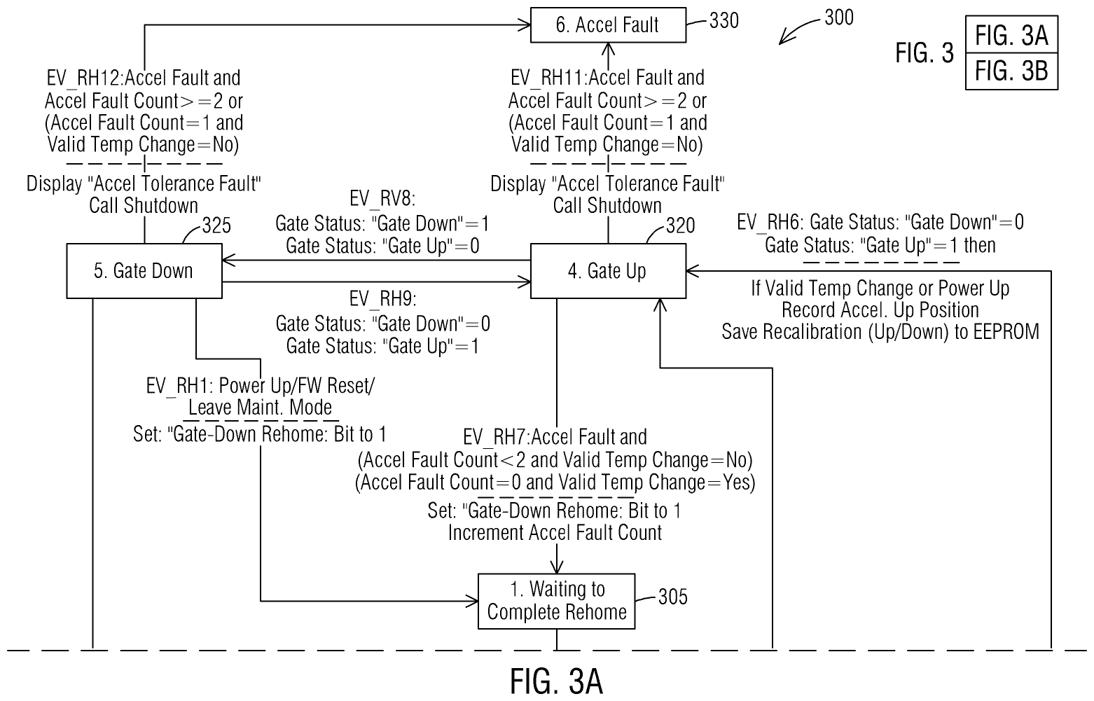

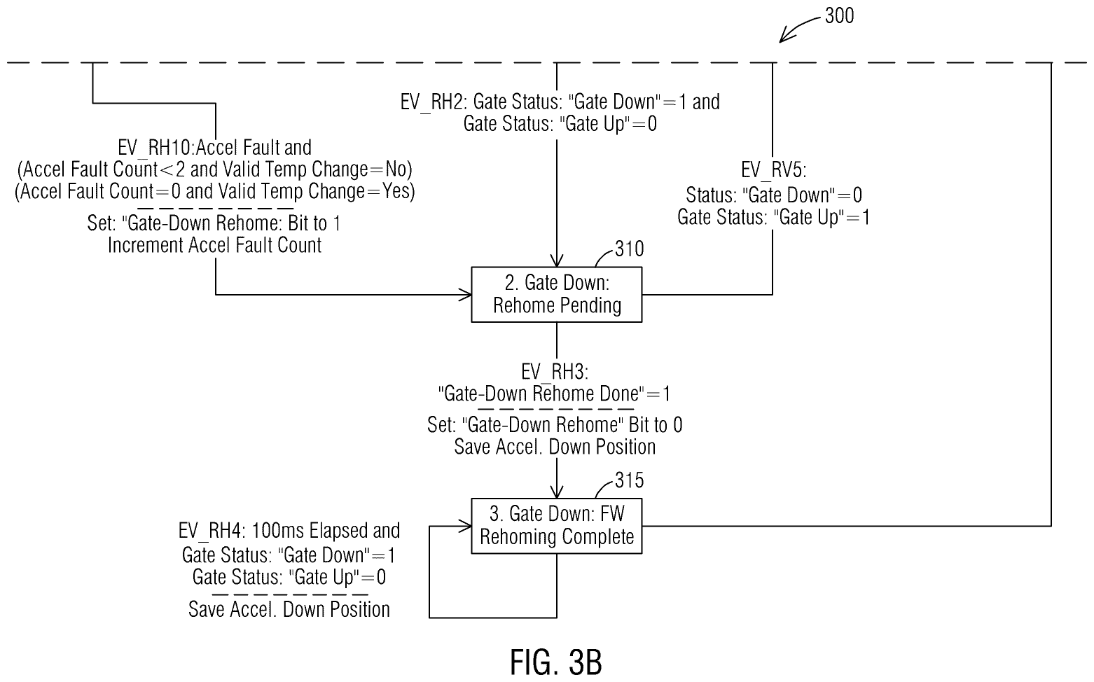

FIG. 3 (FIG. 3A and FIG. 3B as split parts of FIG. 3) illustrates a method 300 to auto-calibrate the accelerometer 205 and/or the hall-sense position counter 210 when they are in disagreement due to the drift of either due to temperature or due to some other phenomenon in accordance with an embodiment of the present disclosure. Reference is made to the elements and features described in FIGS. 1-2. It should be appreciated that some steps are not required to be performed in any particular order, and that some steps are optional.

The method 300 comprises a step 305 of waiting to complete rehome. The method 300 further comprises a step 310 of gate down, rehome pending. The method 300 further comprises a step 315 of gate down FW, rehoming complete. The method 300 further comprises a step 320 of gate up. The method 300 further comprises a step 325 of gate down. The method 300 further comprises a step 330 of the accelerometer 205 fault.

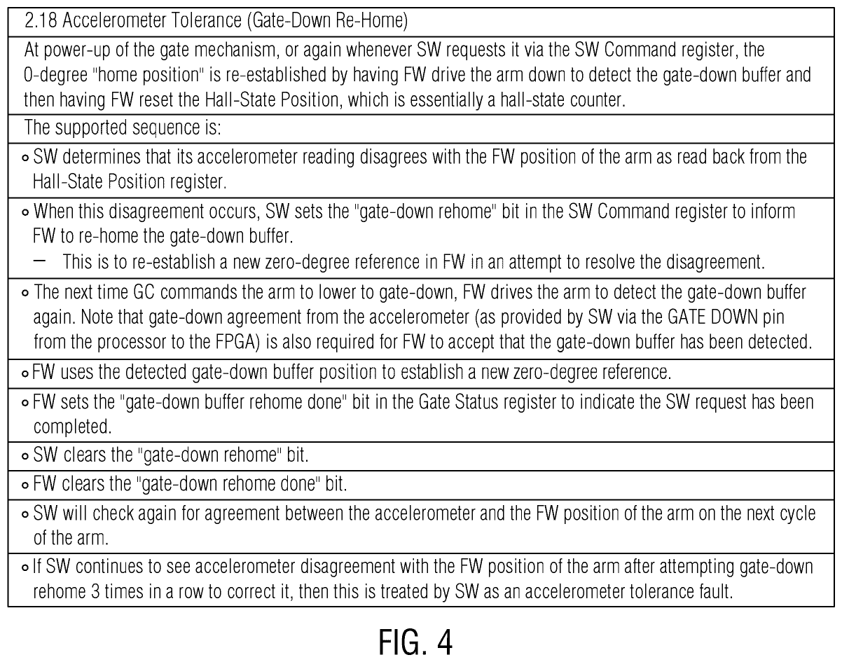

FIG. 4 illustrates a field-programmable gate array (FPGA) for accelerometer tolerance (Gate-Down Re-Home) in accordance with an embodiment of the present disclosure.

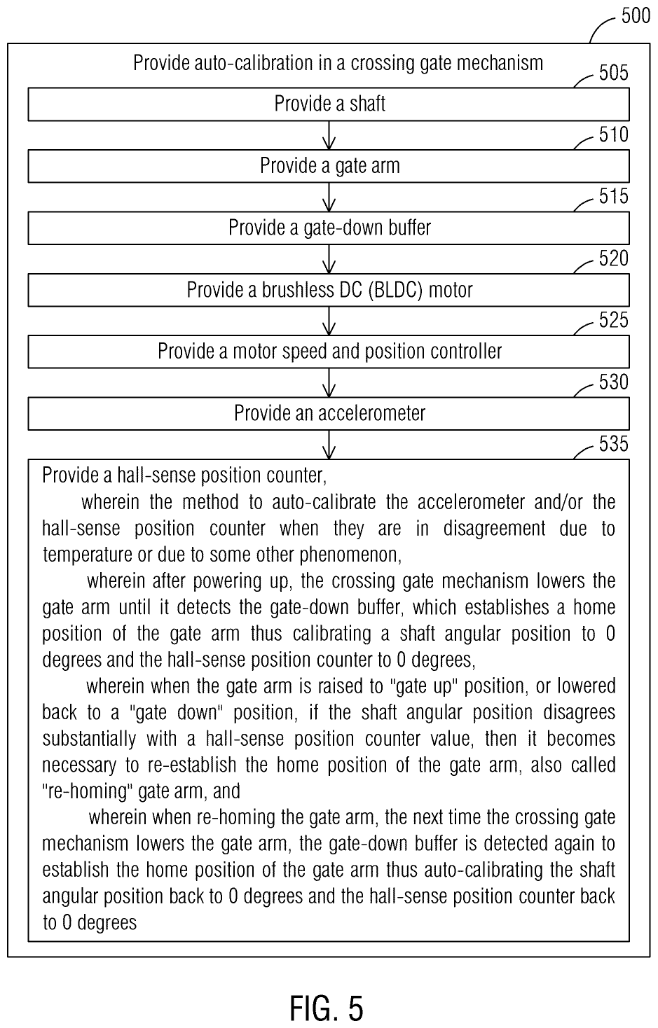

FIG. 5 illustrates a method 500 of providing auto-calibration of the accelerometer 205 and/or the hall-sense position counter 210 in the crossing gate mechanism 212 in accordance with an embodiment of the present disclosure. Reference is made to the elements and features described in FIGS. 1-4. It should be appreciated that some steps are not required to be performed in any particular order, and that some steps are optional.

The method 500 comprises a step 505 of providing a shaft. The method 500 further comprises a step 510 of providing a gate arm. The method 500 further comprises a step 515 of providing a gate-down buffer. The method 500 further comprises a step 520 of providing a brushless DC (BLDC) motor. The method 500 further comprises a step 525 of providing a motor speed and position controller. The method 500 further comprises a step 530 of providing an accelerometer. The method 500 further comprises a step 535 of providing a hall-sense position counter.

The method 500 to auto-calibrate the accelerometer 205 and/or the hall-sense position counter 210 when they are in disagreement due to temperature or due to some other phenomenon. After powering up, the crossing gate mechanism 212 lowers the gate arm 217 until it detects the gate-down buffer 225, which establishes a home position of the gate arm 217 thus calibrating a shaft angular position to 0 degrees and the hall-sense position counter 210 to 0 degrees. When the gate arm 217 is raised to a “gate up” position, or lowered back to a “gate down” position, if the shaft angular position disagrees substantially with a hall-sense position counter value, then it becomes necessary to re-establish the home position of the gate arm 217, also called “re-homing” the gate arm 217. When re-homing the gate arm 217, the next time the crossing gate mechanism 212 lowers the gate arm 217, the gate-down buffer 225 is detected again to establish the home position of the gate arm thus auto-calibrating the shaft angular position back to 0 degrees and the hall-sense position counter 210 back to 0 degrees.

While an accelerometer based auto-calibration system is described here a range of one or more other non-accelerometer based systems are also contemplated by the present disclosure. For example, other non-accelerometer based systems may be implemented based on one or more features presented above without deviating from the spirit of the present disclosure.

The techniques described herein can be particularly useful for a FPGA based motor speed and position controller. While particular embodiments are described in terms of a FPGA, the techniques described herein are not limited to such a FPGA but can also be used with Complex Programmable Logic Devices (CPLDs) or Application-Specific Integrated Circuits (ASICs) or Graphics Processing Units (GPUs).

While embodiments of the present disclosure have been disclosed in exemplary forms, it will be apparent to those skilled in the art that many modifications, additions, and deletions can be made therein without departing from the spirit and scope of the disclosure and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the disclosure has been described with reference to specific embodiments. However, one of ordinary skill in the art appreciates that various modifications and changes can be made without departing from the scope of the disclosure. Accordingly, the specification and figures are to be regarded in an illustrative rather than a restrictive sense, and all such modifications are intended to be included within the scope of disclosure.

Although the disclosure has been described with respect to specific embodiments thereof, these embodiments are merely illustrative, and not restrictive of the disclosure. The description herein of illustrated embodiments of the disclosure is not intended to be exhaustive or to limit the disclosure to the precise forms disclosed herein (and in particular, the inclusion of any particular embodiment, feature or function is not intended to limit the scope of the disclosure to such embodiment, feature or function). Rather, the description is intended to describe illustrative embodiments, features and functions in order to provide a person of ordinary skill in the art context to understand the disclosure without limiting the disclosure to any particularly described embodiment, feature or function. While specific embodiments of, and examples for, the disclosure are described herein for illustrative purposes only, various equivalent modifications are possible within the spirit and scope of the disclosure, as those skilled in the relevant art will recognize and appreciate. As indicated, these modifications may be made to the disclosure in light of the foregoing description of illustrated embodiments of the disclosure and are to be included within the spirit and scope of the disclosure. Thus, while the disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope and spirit of the disclosure as set forth. Therefore, many modifications may be made to adapt a particular situation or material to the essential scope and spirit of the disclosure.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the disclosure.

In the description herein, numerous specific details are provided, such as examples of components and/or methods, to provide a thorough understanding of embodiments of the disclosure. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the disclosure. While the disclosure may be illustrated by using a particular embodiment, this is not and does not limit the disclosure to any particular embodiment and a person of ordinary skill in the art will recognize that additional embodiments are readily understandable and are a part of this disclosure.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A system of auto-calibration is provided in a crossing gate mechanism, the crossing gate mechanism comprising:
a shaft;
a gate arm;
a gate-down buffer;
a brushless DC (BLDC) motor;
a motor speed and position controller;
an accelerometer; and
a hall-sense position counter,
wherein the system to auto-calibrate the accelerometer and/or the hall-sense position counter when they are in disagreement due to temperature or due to some other phenomenon,
wherein after powering up, the crossing gate mechanism lowers the gate arm until it detects the gate-down buffer, which establishes a home position of the gate arm thus calibrating a shaft angular position to 0 degrees and the hall-sense position counter to 0 degrees,
wherein when the gate arm is raised to a “gate up” position, or lowered back to a “gate down” position, if the shaft angular position disagrees substantially with a hall-sense position counter value, then it becomes necessary to re-establish the home position of the gate arm, also called “re-homing” the gate arm, and
wherein when re-homing the gate arm, the next time the crossing gate mechanism lowers the gate arm, the gate-down buffer is detected again to establish the home position of the gate arm thus auto-calibrating the shaft angular position back to 0 degrees and the hall-sense position counter back to 0 degrees.

2. The system of claim 1, wherein there is no need for a rotary encoder attached to the shaft, or for cam lobes to provide an electro-mechanical position of the shaft.

3. The system of claim 1, wherein the gate arm is lowered by the crossing gate mechanism as a barrier to track-crossing traffic when a train is either approaching or passing.

4. The system of claim 1, wherein the gate-down buffer is installed as a mechanical stop within the crossing gate mechanism to establish a 0-degree “gate down” position for the gate arm.

5. The system of claim 1, wherein the shaft is within the crossing gate mechanism and holds the gate arm at one end.

6. The system of claim 1, wherein the accelerometer measures its own angular orientation in X, Y and Z angle values such that the accelerometer is mounted on the shaft so that when the shaft rotates to raise or lower the gate arm, the accelerometer also moves and reports changes in its angular orientation in X, Y and Z angle values.

7. The system of claim 6, wherein a shaft angular position calculator is software run by a Central Processing Unit (CPU) that converts the X, Y and Z angle values into a single shaft angular position.

8. The system of claim 1, wherein the brushless DC motor is a driving force that rotates the shaft and thereby raises or lowers the gate arm.

9. The system of claim 1, wherein the brushless DC motor sends U, V and W hall sense input signals to the hall-sense position counter to increment or decrement that counter when the gate arm is raised or lowered by the brushless DC motor.

10. The system of claim 9, wherein the motor speed and position controller uses a counter value from the hall-sense position counter to drive the A, B and C winding output signals to rotate the brushless DC motor.

11. A method of providing auto-calibration in a crossing gate mechanism, wherein the method comprising:
providing a shaft;
providing a gate arm;
providing a gate-down buffer;
providing a brushless DC (BLDC) motor;
providing a motor speed and position controller;
providing an accelerometer; and
providing a hall-sense position counter,
wherein the method to auto-calibrate the accelerometer and/or the hall-sense position counter when they are in disagreement due to temperature or due to some other phenomenon,
wherein after powering up, the crossing gate mechanism lowers the gate arm until it detects the gate-down buffer, which establishes a home position of the gate arm thus calibrating a shaft angular position to 0 degrees and the hall-sense position counter to 0 degrees,
wherein when the gate arm is raised to a “gate up” position, or lowered back to a “gate down” position, if the shaft angular position disagrees substantially with a hall-sense position counter value, then it becomes necessary to re-establish the home position of the gate arm, also called “re-homing” the gate arm, and
wherein when re-homing the gate arm, the next time the crossing gate mechanism lowers the gate arm, the gate-down buffer is detected again to establish the home position of the gate arm thus auto-calibrating the shaft angular position back to 0 degrees and the hall-sense position counter back to 0 degrees.

12. The method of claim 11, wherein there is no need for a rotary encoder attached to the shaft, or for cam lobes to provide an electro-mechanical position of the shaft.

13. The method of claim 11, wherein the gate arm is lowered by the crossing gate mechanism as a barrier to track-crossing traffic when a train is either approaching or passing.

14. The method of claim 11, wherein the gate-down buffer is installed as a mechanical stop within the crossing gate mechanism to establish a 0-degree “gate down” position for the gate arm.

15. The method of claim 11, wherein the shaft is within the crossing gate mechanism and holds the gate arm at one end.

16. The method of claim 11, wherein the accelerometer measures its own angular orientation in X, Y and Z angle values such that the accelerometer is mounted on the shaft so that when the shaft rotates to raise or lower the gate arm, the accelerometer also moves and reports changes in its angular orientation in X, Y and Z angle values.

17. The method of claim 16, wherein a shaft angular position calculator is software run by a Central Processing Unit (CPU) that converts the X, Y and Z angle values into a single shaft angular position.

18. The method of claim 11, wherein the brushless DC motor is a driving force that rotates the shaft and thereby raises or lowers the gate arm.

19. The method of claim 11, wherein the brushless DC motor sends U, V and W hall sense input signals to the hall-sense position counter to increment or decrement that counter when the gate arm is raised or lowered by the brushless DC motor.

20. The method of claim 19, wherein the motor speed and position controller uses a counter value from the hall-sense position counter to drive the A, B and C winding output signals to rotate the brushless DC motor.
